(19) United States
(12) Patent Application Publication
(10) Pub. No.: US 2016/0217537 A1
(43) Pub. Date: Jul. 28, 2016

(54) REAL ESTATE DATA MANAGEMENT SYSTEM

(71) Applicant: Citiesense, LLC, Norfolk, CT (US)

(72) Inventor: Starling W. Childs, New Haven, CT (US)

(21) Appl. No.: 15/005,681

(22) Filed: Jan. 25, 2016

Related U.S. Application Data
(60) Provisional application No. 62/107,087, filed on Jan. 23, 2015.

(51) Int. Cl. G06Q 50/16; H04L 29/08; G06F 17/30

(52) U.S. Cl. CPC G06Q 50/163; G06F 17/30241; G06F 17/30569; G06F 17/30061; H04L 67/02

(57) ABSTRACT

The present disclosure provides a system and method for creating, managing and distributing real estate related content associated with spatial data and property listing data that represents properties of interest. The system and method also publishes the data for display on an accessible map interface through a web browser.

### CROSS-REFERENCE TO RELATED APPLICATIONS

This application claims priority to co-pending U.S. Provisional Application No. 62/107,087, filed on Jan. 23, 2015, entitled “Real Estate Data Management System”, which is incorporated herein in its entirety by reference.

### BACKGROUND

1. Field

The present disclosure relates to systems and methods for creating, managing, and distributing over a network to remote computing systems real estate related content, including geospatial data related to real estate properties. More particularly, the present disclosure relates to systems and methods for creating, managing, and distributing over a network to remote computing systems standardized parcel data, including standardized geospatial data, related to real estate properties on a parcel by parcel basis and displaying content created by users on a publicly accessible map interface.

2. Description of the Related Art

Internet based platforms that perform residential and commercial real estate related services exist in a variety of formats, and perform a variety of services. Existing Internet based platforms include private market listing service websites and databases. Such listing service websites are private market facilities for the systematic correlation and dissemination of private parcel listing information, such as lot size, asking price, sale price, property taxes and the like. Listing service websites and databases are widely used by real estate brokers and other representative buyers and sellers of real property.

Geographic information systems (GIS) are software based systems designed to capture, store, manipulate, analyze, manage, and present spatial and/or geographical data (collectively referred to herein as “spatial data”). Some existing geographic information systems are Internet based. Geographic information systems allow users to create interactive queries of spatial data, analyze spatial data, edit data in maps based on the spatial data, and present the results of such tasks to users. Geographic information systems have a number of applications including, for example, engineering, planning, and transport/logistics. Typically, public sector projects, such as land planning, real estate development and road building, use geographic information systems to capture, store, manipulate, analyze, manage, and present spatial data. Current Internet based public sector spatial data management exists through a variety of platforms that provide data hosting, map visualization services and data sharing services. Existing public sector spatial data management services exist for managing real estate related data, such as parcel boundary information or tax to maps. Existing public sector web-based spatial data management systems store spatial data in formats, such as a shapefile or SHP file format.

Existing real estate listing service websites are not designed to present real estate properties of interest on the same map as government controlled spatial data about a municipality's economic development initiatives, and development plans and recent development activity in a particular geospatial region. Whereas, public sector based spatial data management systems are not designed to use or present private listing information from a publicly accessible, crowd-sourced content management system.

### SUMMARY

Some embodiments of the real estate data management system according to the present disclosure provide municipalities with an aesthetically consistent or otherwise standardized web presence for presenting information about local land use regulations, property details about properties of interest, demographic data and other public sector datasets. Other embodiments of the real estate data management system provide users with a standardized map visualization of municipal land user regulation policies, such as, but not limited to local government zoning maps. Some embodiments of the real estate data management system also provide public sector website users with method for crowd-sourcing data from municipal agencies and private users with accounts on the system to consolidate a municipality's system for sharing information with the general public that pertains to urban economic development and affiliating the information directly with city parcels.

Some embodiments of the real estate data management system enable municipalities to standardize the delivery of economic development related information to the general public by way of a map-based web interface. Other embodiments of the real estate data management system also enable municipalities to display information in a standardized format pertaining to economic development related activity in specific municipal districts, such as, but not limited to neighborhood districts and planning districts. Some embodiments may also enable municipalities to visualize and present metrics pertaining to urban development in a standard format across multiple municipalities. Some embodiments may enable users to search a database of properties of interest and filter results based on parameters such as, but not limited to acreage of a property of interest, proximity of a property of interest to a point on a map, or the status of a property of interest whether currently a completed development project or a project that is in progress as a real estate development under construction or available, whether for acquisition and development or for lease. Some embodiments enable the general public to comment on and provide feedback about specific information pertaining to parcels that represent properties of interest.

In one exemplary embodiment, the present disclosure provides a computer-implemented method for publishing standardized parcel data over a network to remote public users based upon selected properties of interest. The method comprises uploading from remote sources raw format data, wherein the raw format data comprises spatial data that is uploaded by users using a spatial data intake application, and property listing data that is uploaded using a property listing application. The method also includes standardizing the raw format data to create standardized parcel data, wherein the standardized parcel data is associated with as plurality of properties of interest, and storing the standardized parcel data in a database. Public users are presented with a web-page for selecting, at least one property of interest from the plurality of properties of interest, and once selected the method publishes for display on a parcel map interface the standardized parcel data associated with the selected at least one property of interest.

In an exemplary embodiment, a non-transitory computer readable storage medium is provided. The computer readable storage medium stores instructions, which when executed by a computer cause the computer to upload from remote sources raw format data, wherein the raw format data comprises spatial data that is uploaded by users using a spatial data intake application, and property listing data that is uploaded using a property listing application. The instructions also cause the computer to standardize the raw format data to create standardized parcel data, wherein the standardized parcel data is associated with a plurality of properties of interest, and store the standardized parcel data in a database. The instructions also cause the computer to present to public users a web-page for selecting at least one property of interest from the plurality of properties of interest, and to publish, through a remote web browser, for display on a parcel map interface the standardized parcel data associated with the selected at least one property of interest.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a block diagram of an exemplary embodiment of an networked based computing environment incorporating the real estate data management system according to the present disclosure;

FIG. 2 is a block diagram of an exemplary embodiment of the real estate data management system according to the present disclosure connected to users via the Internet;

FIG. 3 is a block diagram of a real estate data management system computing, environment;

FIG. 4 is an exemplary flow diagram for the intake and standardizing of spatial data into the real estate data management system;

FIG. 5 is an exemplary user entity relationship diagram for the real estate data management system;

FIG. 6 is an exemplary flow diagram for selecting a property of interest and adding a project or listing to the real estate data management system;

FIG. 7 is a screen shot of an exemplary projects dashboard according to the present disclosure;

FIG. 8 is a screen shot of an exemplary page for adding a project or listing to the real estate data management system;

FIG. 9 is an exemplary map interface output by the real estate data management system displaying a neighborhood within a certain geographic area;

FIG. 10 is another exemplary map interface output by the real estate data management system displaying projects or listings for properties of interest;

FIG. 11 is an exemplary analytics dashboard output by the real estate data management system of the present disclosure;

FIG. 12 is an exemplary flow diagram for public users to navigate through the real estate data management system;

FIG. 13 is a block diagram of an exemplary embodiment of a public transaction architecture of the real estate data management system; and

FIG. 14 is a table listing raw format spatial data and property listing data which is then standardized into standardized parcel data.

### DETAILED DESCRIPTION

The present disclosure provides a network based system (also referred to herein as the “platform”) that enables various users to upload real property parcel data from spatial data sources and property listing data sources, and to create, manage and distribute standardized parcel data pertaining to parcels or property boundaries that represent “properties of interest” through a consistent user experience for retrieving and displaying data stored in a spatial database. A property of interest is described in various sections of the present disclosure and includes user defined real estate property that can be based of private listing information, such as an individual owner listing property for sale on a real estate marketplace website, or public listing information, such as the multiple listing service (MLS).

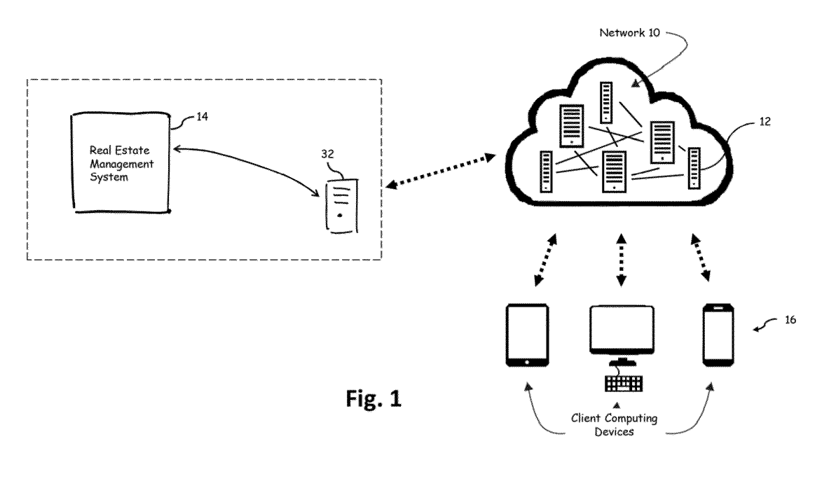

Referring, to FIG. 1, an exemplary network based computing environment incorporating the real estate data management system is shown. In this exemplary embodiment the network topology may be, for example, a local area network (LAN), a wide area network (WAN), a wireless wide area network, a circuit-switched telephone network, a Global System for Mobile Communications (GSM) network, Wireless Application Protocol (WAP) network, a WiFi network, an IEEE 802.11 standards network, various combinations thereof, etc., and the network computing environment may be the Internet (or web) or a cloud based computing environment. The network computing environment 10 includes one or more computing nodes 12, where the real estate data management system 14 resides. Local for client) computing devices used by public and non-public users, such as, for example, personal digital assistants (PDA) or mobile telephones, desktop computers, laptop computers, and/or mobile computer systems may communicate with the real estate data management system 14 via network 10 and a local web browser. The nodes 12 may also communicate with one another. The nodes may be grouped physically or virtually, in one or more networks, such as Private, Community. Public, or Hybrid networks and cloud computing environments, or a combination thereof. This allows the network computing environment 10 to provide infrastructure and/or software for which public and non-public users do not need to maintain resources on a local computing device, except for a tool to communicate to the network, such as a web browser. It is understood that the types of user computing devices shown in FIG. 1 are intended to be illustrative, and that computing nodes 12 and network computing environment 10 can communicate with any type of computerized device over any type of network and/or network addressable connection using, for example, a web browser.

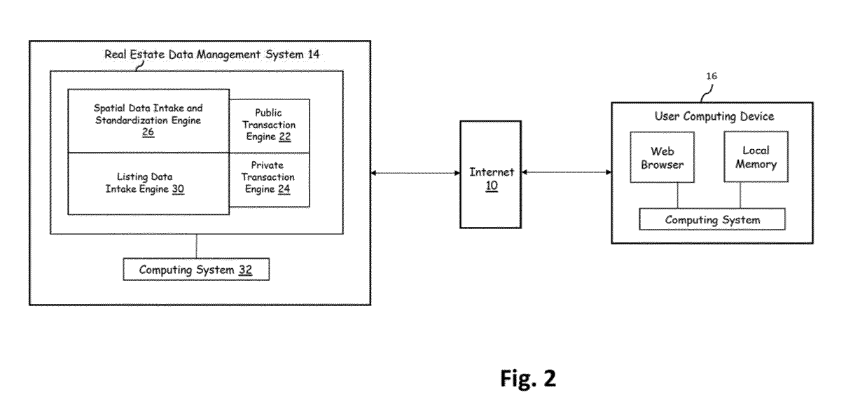

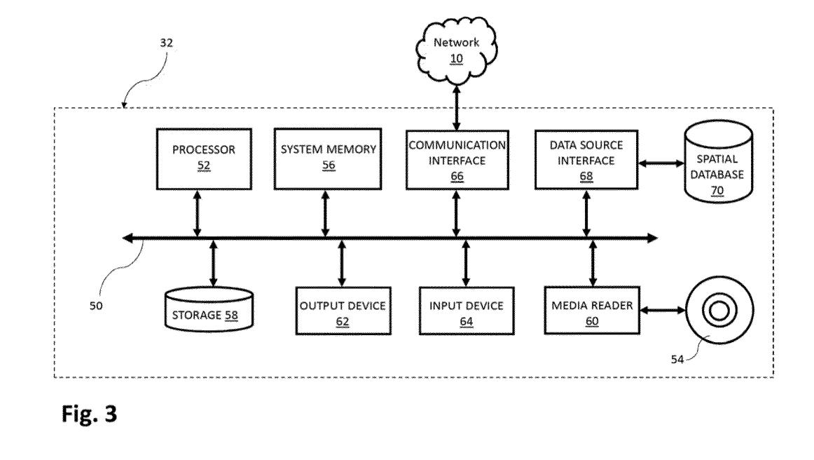

Referring now to FIG. 2, an exemplary embodiment of the real estate data management system 14 in a network environment is shown. In this embodiment, the real estate data management system 14 includes a public transaction engine 22, a private transaction engine 24, a spatial data intake and standardization engine 26, and a listing data intake engine 30. The public transaction engine 22 runs in the computing system 32 and is a communication interface between the computing network 10, and the spatial data intake and standardization engine 26 and the listing data intake engine 30. The public transaction engine 22 permits public users to access standardized parcel data stored in the spatial database 70, seen in FIG. 3, via different pages presented to public users, as will be described in more detail below. The public transaction engine 22 also facilitates communication between the spatial data intake and standardization engine 26 and the listing data intake engine 30 with spatial parcel dataset sources, such as government sponsored open data portals, and property listing sources, such as MLS, to either automatically or manually pull spatial parcel data and property listing data into the real estate data management system 14. The private transaction engine 24 operates similar to the public transaction engine 22 except that the private transaction engine 24 facilitates communication between Individual Accounts and the spatial data intake and standardization engine 26 and the listing data intake engine 30, such that certain non-public users can upload spatial data and/or property listing data into the real estate data management system 14.

Referring to FIG. 3, a block diagram of an exemplary embodiment of the real estate data management computing environment 32 is shown. In this exemplary embodiment, the computing system 32 is interconnected via a bus 50. The computing system 32 includes a processor 52 that executes software instructions or code stored on, for example, to computer readable storage medium 54 or stored in system memory 56, e.g., random access memory, or storage device 58, to perform the real estate data management services disclosed herein. The processor 52 can include a plurality of cores. The computing system 32 of FIG. 3 may also include a media reader 60 to read the instructions from the computer readable storage medium 54 and store the instructions in storage device 58 or in system memory 56. The storage device 58 provides storage space for retaining static data, such as program instructions that could be stored for later execution. Alternately, with in-memory computing devices or systems or in other instances, the system memory 56 would have sufficient storage capacity to store much if not all of the data and program instructions used for the security provisioning orchestration system, instead of storing the data and program instructions in the storage device 58. Further, the stored instructions may be further compiled to generate other representations of the instructions and dynamically stored in the system memory 56. In either embodiment, the processor 52 reads instructions from the storage device 58 or system memory 56, and performs actions as instructed.

The computing system 32 may also include an output device 62, such as a display, to provide visual information to certain users, and an input device 64 to permit certain users or other devices to enter data into and/or otherwise interact with the computing system 32. One or more of the output or input devices could be joined by one or more additional peripheral devices to further expand the capabilities of the computing system 32, as is known in the art.

A communication interface 66 is provided to connect the computing system 32 to the network 10 and in turn to other devices connected to the network 10, including public and non public users, servers, data stores, and interfaces. A data source interface 68 provides access to a data source (e.g., spatial database 70), typically via one or more abstraction layers, such as a semantic layer, implemented in hardware or software. For example, the data source. 70 may be accessed by user computing devices via network 10. The data source may include databases, such as, relational, transactional, hierarchical, multi-dimensional (e.g., OLAP) databases, object oriented databases, and the like. Further, the data sources may include tabular data (e.g., spreadsheets, and delimited text files), data tagged with a markup language (e.g., XML data), transactional data, unstructured data (e.g., text files, screen scrapings), hierarchical data (e.g., data in a file system, XML data), files, a plurality of reports, and any other data source accessible through art established protocol, such as Open Data Base Connectivity (ODBC) and the like. The data source can store spatial data, property listing data and standardized parcel data used by the real estate data management system of the present disclosure.

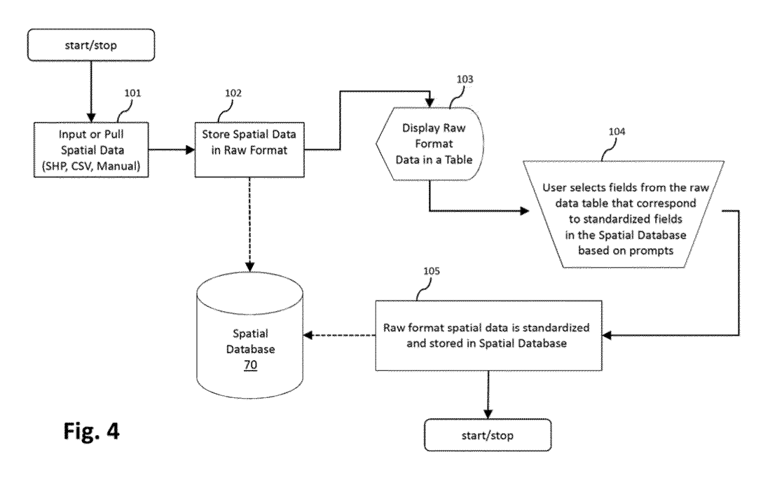

Referring to FIGS. 2 and 4, in order to provide the real estate data management services according to the present disclosure, the computing system 32 intakes, e.g., pulls, spatial data and associated metadata (collectively “spatial data”) via the spatial data intake and standardization engine. 26, and pulls property listing data via the listing data intake engine 30. The spatial data and property listing data are then stored in a “raw format” in the spatial database 70. Raw format data is in a file type native to the source of the spatial data and the property listing data. The spatial data and property listing data are related to one or more parcels of land, and include, for example, map coordinates, a defined map projection system, and Spatial Reference System identifiers (SRID), lot dimensions, square footage of the property and/or property type. As an example, spatial data in a “raw format” would be data retrieved from a spatial database or a spatial data file that a non-public user adds to the real estate data management system. The data input in a raw format may be in, for example, a shapefile (SHP), a comma-separated values (CSV) file, a keyhole markup language (MIL) file, a ZIP file (for SHP), a GPX (or (GPS Exchange) file, or an XLS file. The intake of spatial data and property listing data may be from one or more resources that are available via the network 10. The spatial data and property listing data (also referred to herein as “raw format data”) is pulled via the network 10, from available databases and systems that provide such data. Examples of such systems and databases include government sponsored open data portals and the MLS system. The raw format data is dynamic in nature, such that the spatial data intake and standardization engine 26 and the listing data intake engine 30 can regularly pull raw format data for intake on, for example, as weekly basis. The raw format data are then stored in the spatial database 70, which may also be a PostgreSQL database.

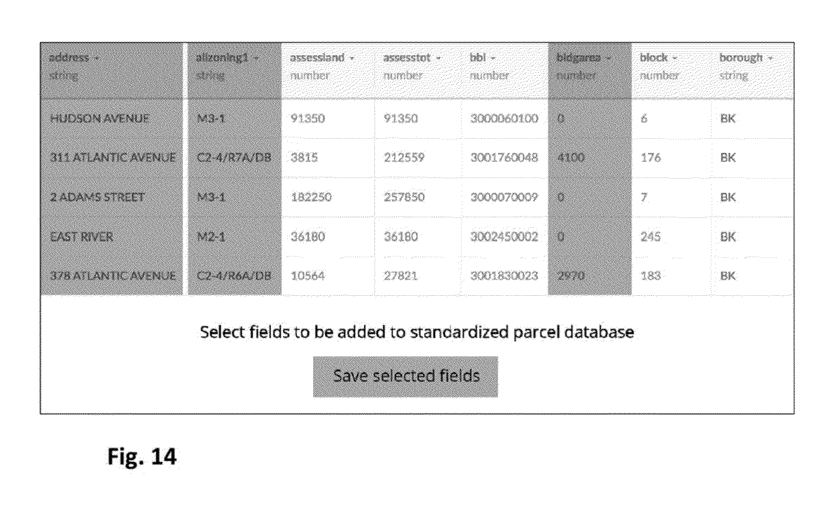

The raw format data is then standardized for subsequent processing by the real estate data management system 14 using the spatial data intake and standardization engine 26. FIG. 4 also provides an exemplary flow for standardizing the raw format data that may be in, for example, a shapefile or SHP file format, into a file format used by the real estate data management system of the present disclosure, such as a Geospatial Javascript Object Notation (geoJSON) format. While the present disclosure notes that the geoJSON format is used by the real estate data management system, one skilled in the art would readily recognize that other data formats may be used by the real estate data management system. To standardize the raw format data, the raw format data and standardized fields or labels, such as an address field, a polygon field, an ownership field, and/or an assessment field, are displayed or presented to non-public users in as predefined format. The predefined format may be, for example, a table (seen in FIG. 14) via a web interface, e.g., a web browser (at step 103). A user then selects fields from the table corresponding to standardized fields (at step 104) so that the raw format data is standardized and stored in the spatial database (at step 105) as standardized parcel data. The standardized parcel data managed in the spatial database 70 is directly associated with property boundaries, commonly known as parcels or tax lots of a set geographic area typically ranging between as small in size as 0.01 acre to as large as 20 acres or more.

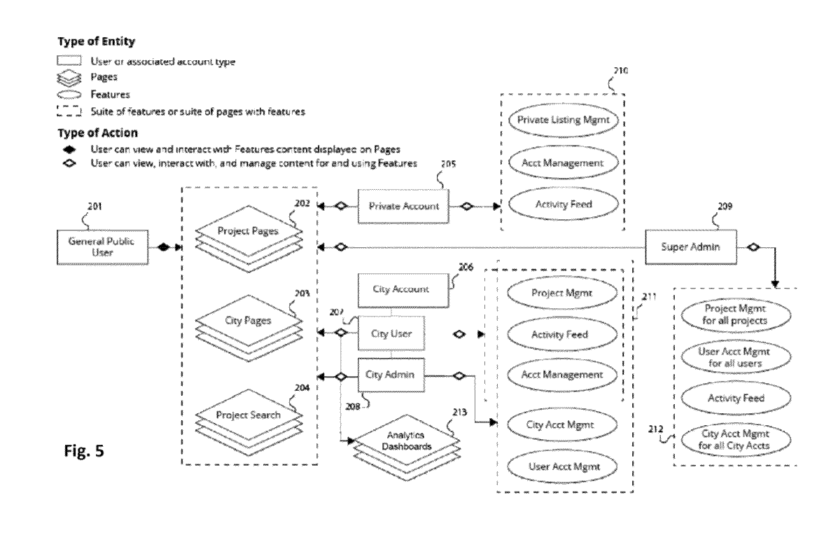

Referring to FIG. 5, the real estate data management system 14 permits different users access to the system 14. A user of the real estate data management system 14 may be a public user, an account based user, administrative user and/or as private user. Different users have different access to the various accounts and/or functions of the real estate data management system 14. Public users 201 are users of the real estate data management system with limited access to the system's content management features for the standardized parcel data. Public users are permitted access to publicly accessible pages and features, including Project Pages (202), City Profile Pages or City Pages (203), and the Project Search Page (204).

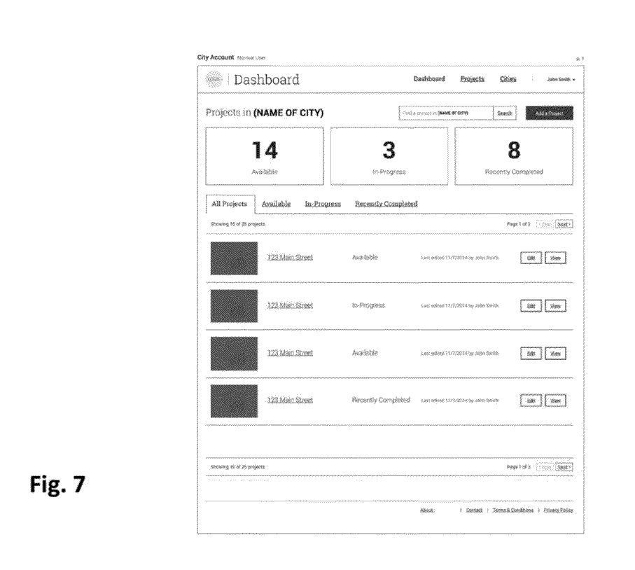

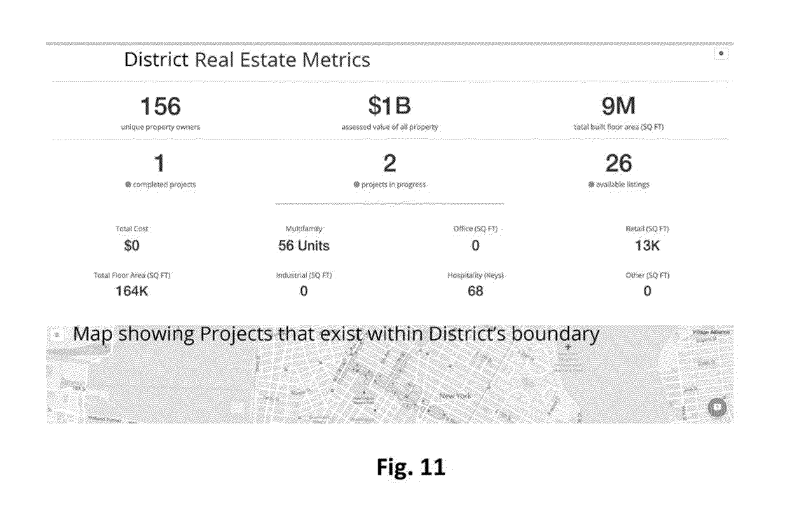

An account based user is associated with one or more accounts. An account can be an Enterprise account, or an account can be an Individual account. The real estate data management system 14 can have many Enterprise accounts and many individual accounts. An example of an Enterprise account is a City Account 206, which is an account related to a local jurisdiction, often a municipality, that may be managed collectively by public sector affiliates of as local jurisdiction, such as economic development agency staff members or municipal staff members. A City Account 206 can be made up of one or more sub-entities. City Accounts may also include analytics dashboards 213, seen in for example FIG. 7, that track, quantify and re-port on standardized parcel data published on Project Pages 202 within predetermined or user defined spatial boundaries representing districts within a city. For example, FIG. 11 shows exemplary standardized parcel data published on an analytics dashboards 213.

A City Account 206 enables its users to manage and share content about properties of interest through the real estate data management system 14, and to publish or display the content on a “Project Page” (202) where it is publicly accessible by public users, as will be described in more detail below. In the exemplary configuration shown in FIG. 5, there are two City Account users, City Users 207 and City Administrators 208. In this exemplary embodiment, content in City Account 206 can be managed by the City Users 207 and the City Administrators 208. In addition, City Administrators 208 are users who can manage or control the account settings for a. City Account, and create, edit and delete accounts for the City Users 207.

An example of an individual account is Private Account 205, which is a type of account intended for entities or users that do not qualify as an Enterprise account. Private Account users are users that manage content pertaining to privately owned and operated real estate, e.g., commercial real estate. Both a City Account 206 and a Private Account 205 enable their respective, users to manage parcel content through the real estate data management system 14, and to publish or display the content on a “Project Page” (202) where it is publicly accessible by public users.

Continuing, to refer to FIG. 5, a Project Page 202 is a webpage with content about a property of interest, such as a real estate listing for an available property for sale or for lease, a real estate development project in planning or under construction, or a recently completed real estate development project. The Project Page is accessible by public and non-public users, however the system enables non-public users to control the visibility of particular fields of information on a Project Page 202, such as the cost of the project or the name of the real estate developer responsible for a real estate development project. A City Page 203 is a webpage that includes one or more interactive maps of a city that are accessible by public and non-public users. The system publishes content to the one or more publicly accessible interactive maps from the spatial data intake and standardization engine 26, and the listing data intake engine 30. The real estate management system enables public and non-public users to interact with and filter standardized parcel data from the spatial database 70, and visualize results of a filter preset via the one or more interactive maps on a City Page. A Project Search Page 204 is a filter or search facility that enables public and non-public users of the real estate data management system to search or filter the Project Pages 202 published using the real estate data management system and saved in the spatial database 70. The Project Search Page 204 enables public, and non-public users to filter results of a search based on specific fields from the standardized parcel data for a property of interest, such as property type, lot size, listing type, project status and floor area.

An administrative user, such as Super Administrator 209, is an entity with access to all real estate data management system features, and controls data management processes for the spatial database 70, including the account settings of other entities, e.g., Enterprise accounts and Individual accounts. For example, a Super-Administrator 209 can create new user accounts for City Users 207 and City Administrators 208. For ease of description, City Users 207, City Administrators 208, Super-Administrators 209, and/or Private Account users may also be collective referred to herein as “non-public users.”

Continuing to refer to FIG. 5, a suite of features for Private Accounts 210 enables Private Account users of the real estate data management system to publish and manage content for a Project Page. This includes the capability of creating, editing, deleting and publishing web pages with content about a property of interest represented on the Project Pages 202. The property of interest could represent a real estate project, such as a commercial real estate listing for a property for sale or for lease, or a real estate development project under construction.

Similar to suite of features for Private Accounts 210, the suite of features for the City Accounts 211 enables City Account users of the real estate data management system to publish and manage content for one or more Project Pages 202. This includes the capability of creating, editing, deleting and publishing web pages with content about a property of interest represented on the Project Pages 202. The property of interest could represent a real estate project, such as a commercial real estate listing, for a property for sale or for lease, or a real estate development project under construction. Additionally, the real estate data management system enables City Account users to manage content for any property of interest within the spatial boundary of the city that the City Account is associate with. For example, if the spatial data within the standardized parcel data associated with a property of interest represented on a Project Page 202 exists within the spatial boundary of the city that manages the City Account, then such City Account users can edit the content published on that Project Page 202 even if a Private Account user created the webpage using his or her Private Account suite of features 210.

Similar to the suite of features for City Accounts 211, the suite of features for the Super Administrator 212 enables administrator users of the real estate data management system to manage content of any Project Page 202 saved in the real estate data management system. The administrator users are able to edit any Project Page 202 in the real estate data management system, regardless of which type of non-public user created the page.

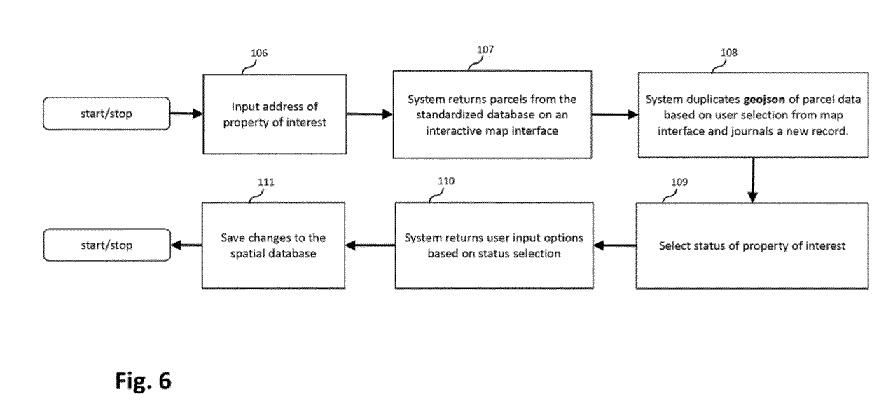

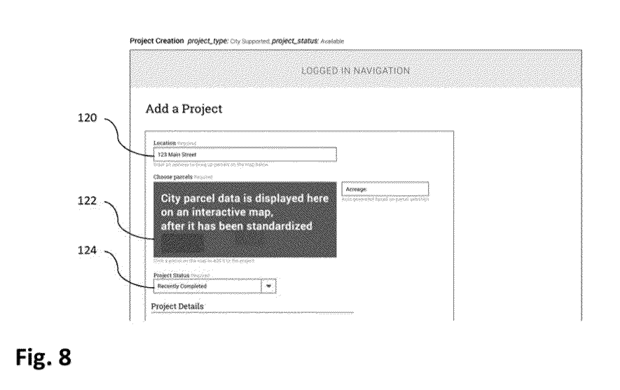

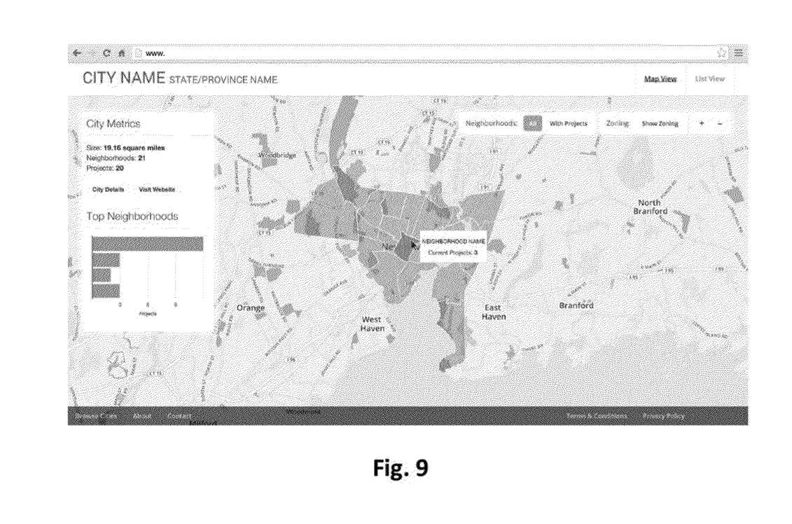

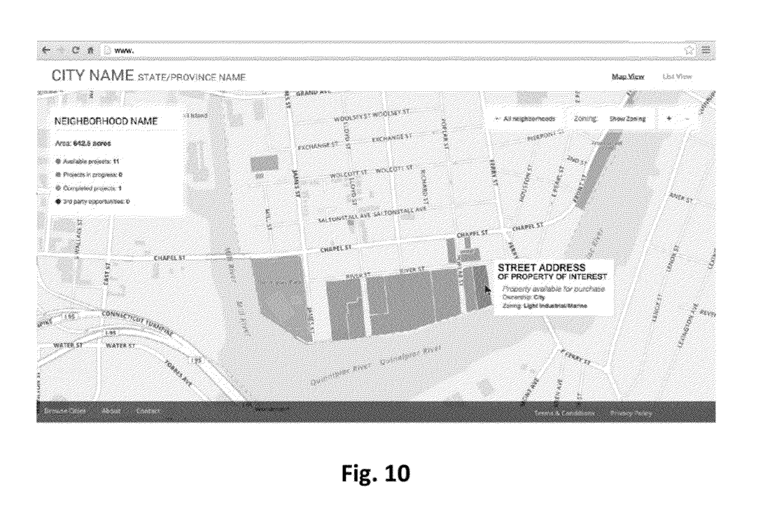

Referring now to FIGS. 5, 6 and 8, processes of the real estate data management system 14 according to the present disclosure can vary based on a series of input prompts entered in different navigation webpages of the real estate data management system 14, such as the “add a project” webpage (seen in FIG. 8e that relates to a development status of a “property of interest.” Properties of interest are selected by users in for example the “Project Status” field 109 (seen in FIG. 6) and represent real estate development projects at various stages of development, such as a project status that is “available,” “in-progress,” or “completed.” The content that, for example, City Users 207 or Private Account users can manage through a City Account 206 or Private Account 205 corresponds to property boundary regions, e.g., polygons, that represent properties of interest. City User 207 or Private Account users are provided with specific fields that relate to the status of a parcel or a group of parcels, such as current land use or total cost of a recently completed real estate development. The City User 207 or Private Account users may then provide content for the field that the City User 207 or Private Account user considers appropriate based on prompts for the input field. Users of City Accounts 206 and Private Accounts 205 of the real estate data management system 14 enables City Users 207 or Private Account users to publish projects or listings for properties of interest, to a standardized interactive map of a city, represented as city pages 203, that is then accessible by public users, as seen for example in FIGS. 9 and 10. Additionally, public and non-public users may filter standardized parcel data of published properties of interest, that is once a City User 207 or a Private Account user has added a project into the real estate data management system 14, and the project is published, the project can be searched for by users (e.g., public users 201, city users 207, city admin users 208 and/or administrative users) using query filters, and return results based on the specific query filter parameters represented as Project Search Page 204.

Referring again to FIG. 4, a more detailed description of the spatial data intake and standardization process is provided. Initially, the real estate data management system 14 may pull spatial data from, for example, government, sponsored open data portal sources noted above. The non-public user may be directed by the real estate data management system 14 via web browser prompts to upload one or more files containing raw format data to the real estate data management system 14 (Step 101). To upload the raw format data, the real estate data management system 14 allows a non-public user to drag-and-drop the one or more files containing raw format data into the spatial database 70 using the user's computer system and web browser. The drag-and-drop feature allows the non-public user to drag, for example, a zipped SHP file from the source location into the spatial database 70 using the non-public user's web browser and dropping the zipped SUP file anywhere in that web browser window in order to import or upload the raw format spatial data into the spatial database 70 (Step 102). In addition, at Step 103, the non-public, user is prompted by the remote real estate data management system with an interface that displays the raw format data in a table, see for example FIG. 14, and enables the non-public user to sort the raw format data before it is standardized by the real estate data management system 14 (Step 104). The standardized parcel data is then added to the spatial database 70 (Step 105). The raw format data is sorted by standardization fields that pertain to a standardized format in the real estate data management system's spatial database 70. These standardization fields include, for example, a field for parcel location or address, a field for parcel geometry coordinates, e.g., the coordinates of the vertices of the parcel polygon, a field for parcel ownership information, and a field for parcel value assessment information.

Based on the fields that the non-public user identifies as relevant to the real estate data management system's standardized format for the spatial database 70, the real estate data management system 14 standardizes the raw format data by transferring the sorted raw format data in the fields that the non-public user identifies from the raw format data to a concatenated dataset of parcels stored in the real estate data management system's spatial database 70. The raw format data has now been standardized as standardized parcel data, and is stored and managed in a spatial database 70 (Step 105) for remote distribution to public and non-public users. Table 1 below shows an example of standardized parcel data.

TABLE 1
{“type”:“Feature”,“geometry”:{“type”:“MultiPolygon”,“coordinates”:[[[[
−72.92594,41.32229],[−72.92599,41.32141],[−72.92878,41.32154],[−72.92888,41.32177],[
−72.92861,41.32266],[−72.92854,41.32286],[−72.92739,41.32264],[−72.92592,41.32236],[
−72.92593,41.32235],[−72.92594,41.32229]]]]},“properties”: {“country”:“use”,“location”:
“115 Munson St”,“city”:“New Haven”,“state”:“Connecticut”,“zone”:“PDD 49”,
“zone_name”:“Planned Development District”,“created_at”:“5-07-28T23:06:32Z”,
“updated_at”:“2014-05-13T21:36:40Z”,“project_status”:“1”,“neighborhood”:“Prospect
Hill”,“lon”:“−72.92735849”,“lat”:“41.32213343”,“city_id”:“ct-new-haven”,“plan_id”:
“115-munson-st”,“city_slug”:“new-haven”,“state_slug”:“ct”,“hood_slug”:“prospect-
hill”,“shape_area”:“321146.9311”,“image”:“ct-new-haven-115-munson-st.jpg”,
“ownership”:“Private”,“visibility”:1,“database_id”:23}}

Referring to FIGS. 6 and 9, a more detailed description of the process for adding a property of interest will be described. In order to interact with the standardized parcel data stored in the spatial database 70, a non-public user can enter a street address into a search field, such as location field 120 (step 106). If a street address is provided by the non-public user, the real estate data management system 14 returns standardized parcel data from the spatial database 70 by geo-referencing the input street address to the spatial data properties using a geocoder, such as Google Places®.

At Step 107, the real estate data management system 14 retrieves standardized parcel data related to the location entered, and publishes or displays the standardized parcel data on an interactive parcel map interface 122 that enables non-public users to select a single parcel or multiple parcels that constitute properties of interest, see, e.g., the map of FIG. 9.

At Step 108, once the standardized parcel data associated with one or more properties of interest are selected from the interactive parcel map interface 122, the real estate data management system 14 enables the non-public user to perform basic database management processes associate with the selected standardized parcel data.

At Step 109, the real estate data management system 14 prompts a non-public user to associate the selected property of interest with a Project Status from a drop-down menu 124, seen in FIG. 8. The Project Status, e.g., recently completed, in progress or available, of a property of interest represents the current stage of the project in the development process. Options in the drop-down menu attribute to stages of development, such as currently in progress or recently completed, new real estate development opportunity, or commercial property for lease or for sale.

At Step 110, the real estate data management system 14 enables a non-public user to create new data (content) that the real estate data management system 14 provides prompts for. The real estate data management system 14 prompts the non-public user to provide information about the land use status of the parcel, or an assemblage of parcels associated with a property of interest. The prompts pertain to new fields associated with the real estate data management system's standardized parcel data stored in the spatial database, such as, but not limited to project status, programming, financing, design objectives for a development, incentives, cost, floor area, and completion date.

At Step 111, the real estate data management system 14 enables a non-public user to save the new data to the spatial database 70, and also enables the non-public user to display or publish the property of interest along with the new data on a map interface 122, see the map of FIG. 9 for example, where any public or non-public user of the real estate data management system can access standardized parcel data from the spatial database 70 about the property of interest. The real estate data management system 14 also enables a non-public user that has created a property of interest to edit or delete any standardized parcel data associated with the property of interest the non-public user has created at any time.

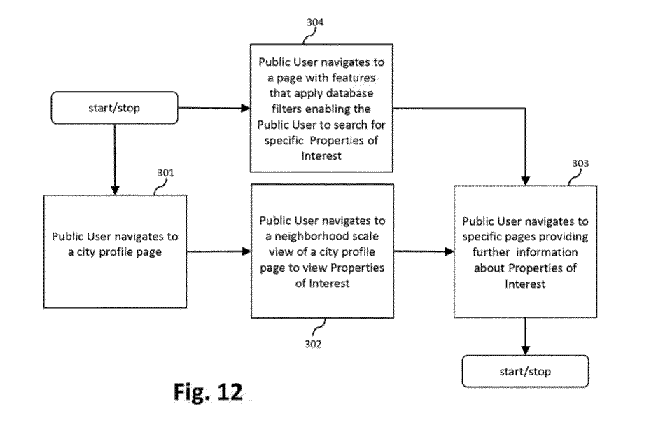

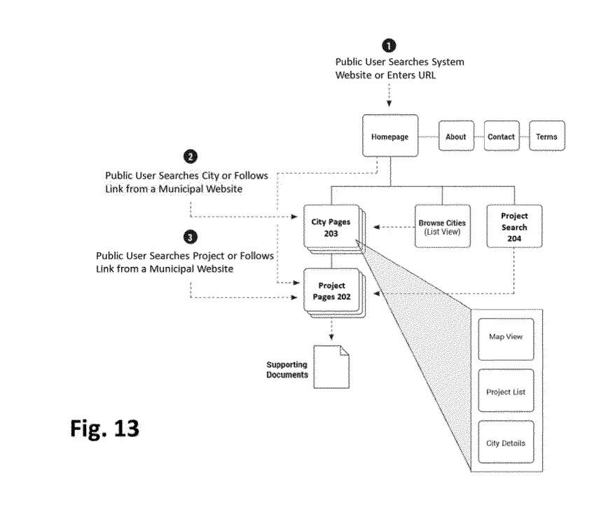

As previously noted and referring to FIGS. 12 and 13, the real estate data management system 14 is a network-based service providing spatial and listing data management processes to an unlimited number of users through a variety of remote computing devices, and typically from a single computing node, such as computing system 32. The real estate data management system 14 enables public users a plurality of ways in which to navigate through the system to obtain standardized parcel data about one or more properties of interest. The present disclosure provides two exemplary ways in which a public user can navigate through the real estate data management system 14 to obtain information about one or more properties of interest. However, one skilled in the art would readily appreciate that there are many ways in which a user can navigate a website to obtain information stored in memory, including navigating through the system to obtain a property of interest. At step 301, in one exemplary configuration to navigate to information about a property of interest is to navigate to a City Profile Page, seen in FIG. 10. Once at as City Profile Page, the public user can interact with available standardized parcel data for the property of interest at a predefined view scale, e.g., a city-wide view scale, that may include neighborhood, district spatial data and land use spatial data. At step 302, from the City Profile Page and the city scale map view, public users can navigate to a neighborhood scale view. At the neighborhood scale view, the public users can view properties of interest that fall within a neighborhood district. At Step 303, the public users can further navigate to properties of interest from the neighborhood view that are associated with a City Account that belongs to the City Profile Page.

Another exemplary way in which a public user can navigate, through the real estate data management system 14 to obtain standardized parcel data about one or more properties of interest is to navigate, to properties of interest from the Project Search Page 204, seen in FIG. 5. Using the Project Search Page, a public user can perform a query, and filter query results based on data sorting criteria, such as square footage of the property or property type, that return specific properties of interest depending on the public user's selected sorting criteria.

The real estate data management system 14 provides public users with a consistent user experience for navigating to different City Profile Pages (see FIG. 10), that are uniquely managed by the non-public users associated with a city's City Account within the real estate data management system 14. The city profile pages provide a map-based interface for navigating to properties of interest (see FIG. 10). The properties of interest displayed on a city profile page are managed either by Non-Public Users associated with the City Account or a Private Account. The city profile pages allow the public users to interact with map visualizations of geospatial data to retrieve and display standardized parcel data from the spatial database 70 pertaining to properties of interest, land use regulations, neighborhood boundaries, and public infrastructure. Additionally, public users are able to connect with other non-public users that manage data associated with properties of interest to share sentiments about properties of interest, inquire about opportunities associated with properties of interest and share or promote properties of interest with other users and non-users of the platform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying, out operations for aspects of the real estate data management system may be written in any combination of one or more programming languages, including the Ruby programming language and Rails programming framework, an object oriented programming language such as Java, Smalltalk, C++ or the like, and conventional procedural programming languages, such as the “C” programming language or similar programming languages. The program code may execute entirely on the user's computer, partly on the users computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the real estate data management system are described above with reference to flowchart illustrations and/or block diagrams of methods, apparatus (systems) and computer program products according to various configurations. It will be understood that each block of the flowchart illustrations and/or block diagrams, and combinations of blocks in the flowchart illustrations and/or block diagrams, can be implemented by computer program instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing, apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be understood that various modifications can be made to the embodiments of the present disclosure without departing from the spirit and scope thereof. Therefore, the above description should not be construed as limiting the disclosure, but merely as embodiments thereof. Those skilled in the art will envision other modifications within the scope and spirit of the invention as defined by the claims appended hereto.

What is claimed is:

1. A computer-implemented method for publishing standardized parcel data over a network to remote public users based upon selected properties of interest, the method comprising:
uploading from remote sources raw format data, wherein the raw format data comprises spatial data that is uploaded by users using a spatial data intake application, and property listing data that is uploaded using a property listing application;
standardizing the raw format data to create standardized parcel data, wherein the standardized parcel data is associated with a plurality of properties of interest;
storing the standardized parcel data in a database;
presenting to public users a web-page for selecting at least one property of interest from the plurality of properties of interest; and
publishing, through a remote web browser, for display on a parcel map interface the standardized parcel data associated with the selected at least one property of interest.

2. The computer-implemented method for publishing standardized parcel data according to claim 1, wherein the raw format data is uploaded by regularly pulling the raw format data from remote spatial data sources and remote property listing sources via a network.

3. The computer-implemented method for publishing standardized parcel data according to claim 1, wherein standardizing the raw format data comprises presenting the raw format data to at least one non-public user in a table format, and the at least one non-public user standardizes the raw format data by selecting one or more fields in the table to form a concatenated dataset of parcels.

4. The computer-implemented method for publishing standardized pared data according to claim 1, wherein publishing the standardized parcel data associated with the selected at least one property of interest comprises providing access to the standardized parcel data through one or more project pages and one or more city pages displayed on remote web browser.

5. A non-transitory computer readable storage medium storing instructions, which when executed by a computer cause the computer to:
upload from remote sources raw format data, wherein the raw format data comprises spatial data that is uploaded by users using a spatial data intake application, and property listing data that is uploaded using a property listing application;
standardize the raw format data to create standardized parcel data, wherein the standardized parcel data is associated with a plurality of properties of interest;
store the standardized parcel data in a database;
present to public users a web-page for selecting at least one property of interest from the plurality of properties of interest; and
publish, through a remote web browser, for display on a parcel map interface the standardized parcel data associated with the selected at least one property of interest.

6. The computer readable storage medium according to claim 5, wherein the raw format data is uploaded by regularly pulling the raw format data from remote spatial data sources and remote property listing sources via a network.

7. The computer readable storage medium according to claim 5, wherein standardizing the raw format data comprises presenting the raw format data to at least one non-public user in a table format, and the at least one non-public user standardizes the raw format data by selecting one or more fields in the table to form a concatenated dataset of parcels.

8. The computer readable storage medium according to claim 5, wherein publishing the standardized parcel data associated with the selected at least one property of interest comprises providing, access to the standardized parcel data through one or more project pages and one or more city pages displayed on remote web browser.
